(19) United States
(12) Patent Application Publication
(10) Pub. No.: US 2008/0001896 A1
(43) Pub. Date: Jan. 3, 2008

(54) Display controller in display device, and method of transferring display data

(75) Inventor: Satoshi Okamura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/822,143

(22) Filed: Jul. 2, 2007

(30) Foreign Application Priority Data
Jul. 3, 2006 (JP) 2006-183156

(51) Int. Cl. G09G 3/36

(52) U.S. Cl. 345/98

(57) ABSTRACT

A display controller comprising: a memory in which a display data is stored; a driver configured to drive a display panel in response to the display data; and a clock generation circuit configured to generate a clock that is used for transferring the display data from the memory to the driver. The generated clock is fed back to adjust a clock frequency of the clock.

### BACKGROUND OF THE INVENTION

1. Field of the Invention

The present invention relates to a display device. In particular, the present invention relates to a technique for controlling a transfer of a display data in the display device.

2. Description of Related Art

A liquid crystal display device provided with a VRAM (Video RAM) in which a display data is stored is known (for example, refer to Japanese Laid-Open Patent Application JP-Heisei-10-97226). In such a liquid crystal display device, the display data needs to be transferred from the VRAM to a segment driver.

FIG. 1 schematically shows a configuration of a typical liquid crystal display device having a VRAM. The liquid crystal display device is provided with an LCD (Liquid Crystal Display) panel 110, a common driver 120 and a segment driver 130. The LCD panel 110 has L×P pixels arranged in a matrix (L and P are natural numbers). Those pixels are formed at intersections of L scan lines X1 to XL extending in a row direction and P data lines Y1 to YP extending in a column direction.

The common driver 120 drives the scan lines X1 to XL in turn. The segment driver 130 drives the data lines Y1 to YP in response to a display data DATA corresponding to the driven scan line. One image is displayed on the LCD panel 110 by driving all the scan lines X1 to XL. The operation of displaying the one image is referred to as “frame”. On the other hand, the operation with respect to one scan line is referred to as “line”.

The liquid crystal display device shown in FIG. 1 is further provided with a transfer controller 140, a VRAM 150 and an oscillator 160. Stored in the VRAM 150 are the display data DATA corresponding to an image to be displayed on the LCD panel 110. In accordance with an instruction by a CPU, the transfer controller 140 reads one display data DATA corresponding to one line from the VRAM 150. Simultaneously, the transfer controller 140 generates a transfer clock XSCL used for transferring the display data DATA, based on a high-frequency clock supplied from the oscillator 160. Then, the transfer controller 140 transfers the display data DATA of the one line to the segment driver 130 in synchronization with the generated transfer clock XSCL.

The inventor of the present application has recognized the following points. With regard to the above-mentioned transfer of the display data DATA, it is necessary to impose the following conditions on the transfer clock XSCL. The conditions will be explained below with reference to FIG. 2.

A frame frequency is represented by fFRM, and a frame period is represented by T (=1/fFRM). Since one frame includes L lines as described above, one line period is represented by T/L (=1/(fFRM×L)). The display data DATA of one line contains data of P pixels corresponding to the one line. The data of P pixels are transferred in synchronization with the transfer clock XSCL during the one line period T/L. A frequency (clock frequency) of the transfer clock XSCL is represented by fTRANS, and its period (clock period) is represented by tTRANS (=1/fTRANS).

As the clock frequency fTRANS is increased, the clock period tTRANS becomes shorter. However, within one clock period tTRANS, it is necessary to read out data of one pixel on average from the VRAM and then transfer the data. Here, a sum of a minimum time required for reading out data of one pixel and a minimum time required for transferring the data of one pixel is represented by tDATA (=1/fDATA). In this case, the one clock period tTRANS should be equal to or more than the minimum time tDATA, otherwise the minimum required processing can not be done within the one clock period tTRANS. Thus, the following relational expression (1) can be obtained.
tDATA≦tTRANS
fDATA≧fTRANS (1)

Meanwhile, as the clock frequency fTRANS is decreased, the clock period tTRANS becomes longer. In this case, the number of clock pulses included in one line period T/L is decreased. However, within the one line period T/L, it is necessary to complete the data transfer associated with the one line (P pixels). In other words, the one line period T/L should be equal or more than the P times the one clock period tTRANS. Otherwise, the number of clock pulses within the one line period T/L becomes deficient and the necessary number of the data transfer can not be completed. Thus, the following relational expression (2) can be obtained.
tTRANS≦T/(L×P)
fTRANS≧fFRM×L×P (2)

By combining the relational expressions (1) and (2), the following relational expression (3) can be obtained. The relational expression (3) represents the “theoretical” conditions imposed on the transfer clock XSCL.
tDATA≦tTRANS≦T/(L×P)
fFRM×L×P≦fTRANS≦fDATA (3)

At an actual design stage, further conditions are imposed on the transfer clock XSCL in addition to the above-described theoretical conditions. The reason is that the clock frequency fTRANS of the transfer clock XSCL is varied due to manufacturing variability and varies depending on change in voltage and temperature during operation. It is necessary to design the clock frequency fTRANS in consideration of the variability. In other words, it is necessary to design the clock frequency fTRANS such that the above-mentioned relational expression (3) is satisfied even if the clock frequency fTRANS varies due to the manufacturing variability or during operation.

The clock frequency fTRANS designed at the design stage is referred to as a “design frequency fTRANS(set)”. On the other hand, the actual clock frequency fTRANS varies in a range from fTRANS(min) to fTRANS(max), depending on the manufacturing variability, operation voltage, operation temperature and the like. For example, it is assumed that the variation range is from 50% to 200% of the design frequency fTRANS(set). In this case, we have to consider that the actual clock frequency fTRANS can vary within the following range.
fTRANS=0.5×fTRANS(set)˜2×fTRANS(set) (4)

By combining the above expressions (3) and (4), the following relational expression (5) can be obtained with regard to the design frequency fTRANS(set)
2×fFRM×L×P≦fTRANS(set)≦0.5×fDATA (5)

As is obvious from a comparison between the relational expressions (3) and (5), the allowable range of the design frequency fTRANS(set) is narrower than the theoretical range.

In recent years, the total number of pixels of an LCD panel is increasing more and more. In the above relational expression (5), the total number of pixels of the LCD panel is represented by “L×P”, and the increase in “L×P” means rise of the lower limit of the design frequency fTRANS(set). As the total number of pixels “L×P” is increased, it is necessary to set the design frequency fTRANS(set) to the even higher value in order to transfer the display data DATA at a higher speed. In other words, as the total number of pixels “L×P” is increased, the allowable range of the design frequency fTRANS(set) becomes even narrower.

As explained above, it is becoming more difficult to technically deal with the increase in the total number of pixels of the LCD panel. This can be demonstrated from another point of view. By transforming the above relational expression (5), the following relational expression (6) can be obtained with regard to the total number of pixels “L×P”.
L×P≦0.25×fDATA/fFRM (6)

This relational expression (6) represents constraint on the total number of pixels, namely, the size of the LCD panel. For example, let us consider a case where the frame frequency fFRM is 60 Hz and the minimum time tDATA (=1/fDATA) is 60 ns. In this case, the maximum value of the total number of pixels L×P is calculated from the expression (6) to be 69444 pixels. To further increase the total number of pixels is technically impossible. In this case, it is impossible to display an image of QVGA size (240×320=76800 pixels).

### SUMMARY

In one embodiment of the present invention, a display controller in a display device is provided. The display controller has: a memory in which a display data is stored; a driver configured to drive a display panel in response to the display data; and a clock generation circuit configured to generate a transfer clock that is used for transferring the display data from the memory to the driver.

According to the embodiment, the transfer clock XSCL generated by the clock generation circuit is fed back to adjust the clock frequency fTRANS of the transfer clock XSCL. For example, the clock generation circuit monitors the transfer clock XSCL generated by itself, and adjusts the transfer clock XSCL such that the monitored clock frequency fTRANS is corrected to a predetermined frequency. As a result, even if the clock frequency fTRANS of the transfer clock XSCL varies due to change in voltage, temperature or the like, the clock frequency fTRANS is immediately set back to the predetermined frequency. That is to say, the clock frequency fTRANS of the transfer clock XSCL is controlled to be maintained at an optimum value.

Therefore, it is not necessary to set the design frequency fTRANS(set) in consideration of the voltage change, the temperature change, the manufacturing variability or the like. The allowable range of the design frequency fTRANS(set) is similar to that in the above-mentioned expression (3) and is given by the following relational expression (7).
fFRM×L×P≦fTRANS(set)≦fDATA (7)

As is obvious from a comparison between the foregoing expression (5) and the expression (7), the allowable range of the design frequency fTRANS(set) becomes wider than the foregoing technique. That is, the constraint imposed on the design frequency fTRANS(set) is relaxed. Thus, it becomes easier to deal with the increase in the total number of pixels of the LCD panel. Also, by transforming the above expression (7), the following relational expression (8) can be obtained with regard to the total number of pixels “L×P”.
L×P≦fDATA/fFRM (8)

As is obvious from a comparison between the foregoing expression (6) and the expression (8), the upper limit of the total number of pixels “L×P” is increased as compared with the foregoing technique. The reason is that it is not necessary to take the margin of variation in voltage, temperature or the like into consideration. For example, let us consider a case where the frame frequency fFRM is 60 Hz and the minimum time tDATA (=1/fDATA) is 60 ns. In this case, the maximum value of the total number of pixels L×P is calculated from the expression (8) to be 277777 pixels. In this case, it is possible to display an image of QVGA size (240×320=76800 pixels).

In another embodiment of the present invention, a method of transferring a display data in a display device is provided. The method includes: (A) generating a transfer clock that is used for transferring the display data; (B) transferring the display data by using the generated transfer clock; (C) counting a number of pulses of the generated transfer clock within a predetermined period; and (D) adjusting the clock frequency of the transfer clock such that the number of pulses within the predetermined period is corrected to a predetermined value.

According to the present invention, the constraint imposed on the transfer clock XSCL is relaxed. It is therefore possible to technically easily deal with the increase in the number of pixels of the display panel. In other words, it is possible to easily realize large screen size (mega-pixel) which requires high-speed transfer of a large amount of data.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram schematically showing a configuration of a typical liquid crystal display device;

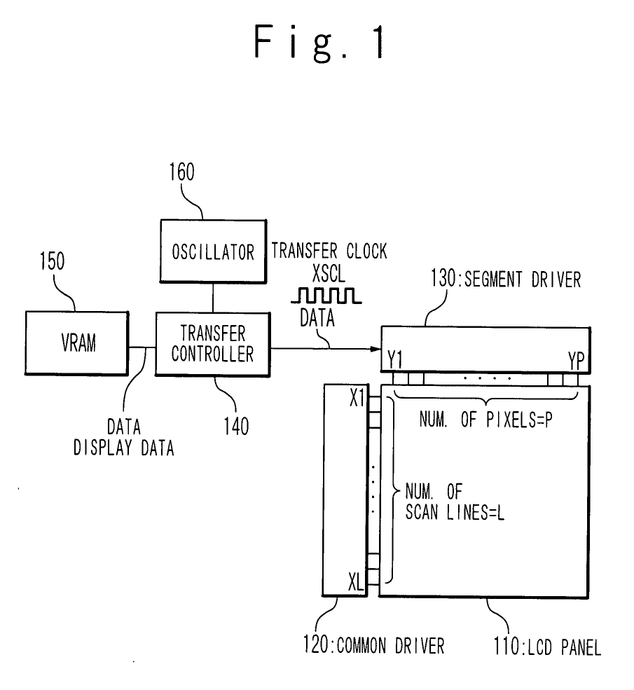

FIG. 2 is a view for explaining conditions imposed on transfer of a display data;

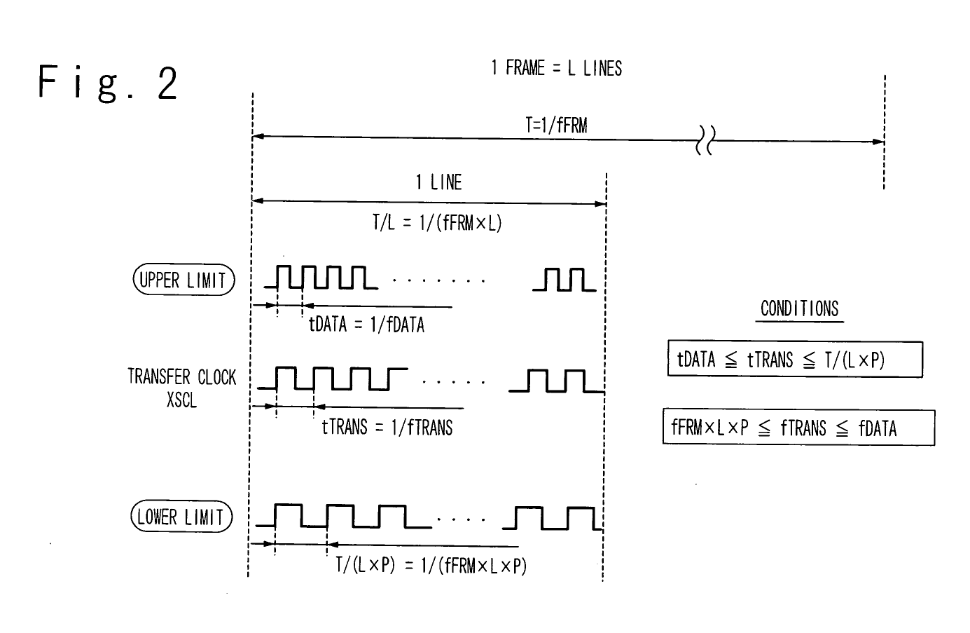

FIG. 3 is a block diagram schematically showing a configuration of a liquid crystal display device according to an embodiment of the present invention;

FIG. 4 is a block diagram showing a configuration of an LCD controller according to the embodiment of the present invention;

FIG. 5 is a block diagram showing a configuration of a transfer clock generation circuit according to the embodiment of the present invention;

FIG. 6 is a flow chart showing a method of transferring a display data according to the embodiment of the present invention;

FIG. 7 is a timing chart showing an example of an operation of the transfer clock generation circuit according to the embodiment of the present invention; and

FIG. 8 is a block diagram showing a modification example of the transfer clock generation circuit according to the embodiment of the present invention.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A display device, a display controller, and a method of transferring a display data according to an embodiment of the present invention will be described below with reference to the attached drawings. In the present embodiment, the display device is exemplified by a dot-matrix type liquid crystal display device.

### 1. OVERVIEW

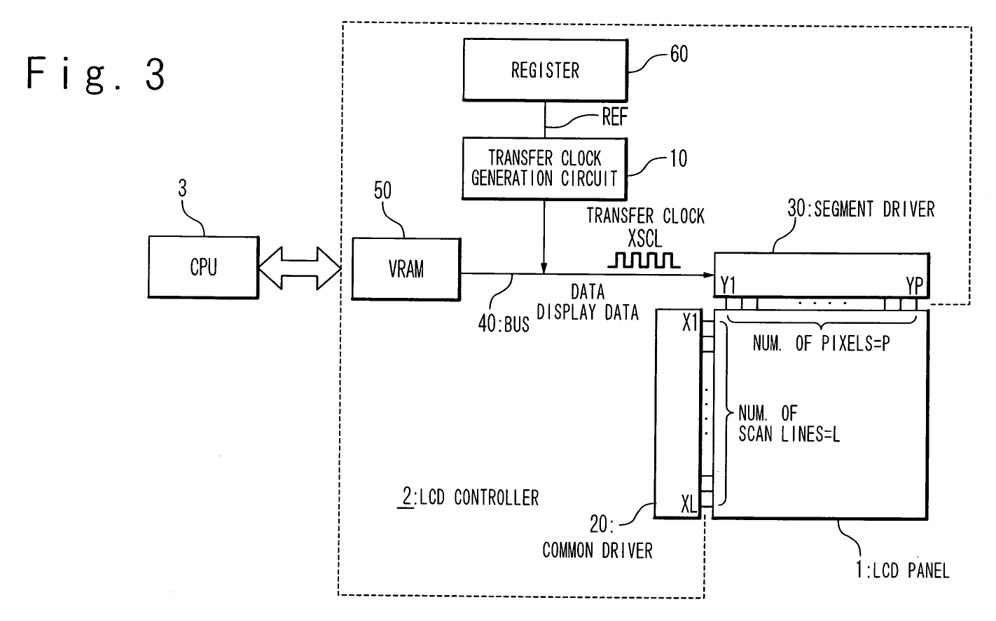

FIG. 3 schematically shows a configuration of the dot-matrix type liquid crystal display device according to the present embodiment. In FIG. 3, the liquid crystal display device is provided with an LCD panel 1, an LCD controller 2 and a CPU 3. The LCD controller 2 controls an image display on the LCD panel 1. The CPU 3 transmits various data and commands to the LCD controller 2.

The LCD panel 1 has L×P pixels arranged in a matrix (L and P are natural numbers). Also, the LCD panel 1 has L scan lines X1 to XL extending in a row direction and P data lines Y1 to YP extending in a column direction. The L scan lines X1 to XL and the P data lines Y1 to YP intersect at L×P intersections, and the pixels are formed at the respective intersections. The L scan lines X1 to XL are connected to a common driver 20, while the P data lines Y1 to YP are connected to a segment driver 30.

The common driver (row driver, line driver) 20 selects a scan line to be driven from the scan lines X1 to XL in turn. Then, the common driver 20 drives the selected scan line (line). Meanwhile, the segment driver (column driver, data driver) 30 drives the data lines Y1 to YP in response to a display data DATA corresponding to the driven line. The segment driver 30 outputs pixel voltages corresponding to the display data DATA of the driven line to the data lines Y1 to YP. The segment driver 30 is connected to a VRAM 50 through a bus 40, and the display data DATA is transferred from the VRAM 50 every line.

The VRAM 50 is a memory used for storing the display data DATA corresponding to an image displayed on the LCD panel 1. The display data DATA of the image are transferred from the CPU 3 and once stored in the VRAM 50. Then, in accordance with the command by the CPU 3, the display data DATA of one line is read out from the VRAM 50 every line and is output to the bus 40. The display data DATA of one line is transferred from the VRAM 50 to the segment driver 30 through the bus 40, in synchronization with a transfer clock XSCL. The segment driver 30 has a latch circuit and a line memory for storing the transferred display data DATA of the one line.

It is a transfer clock generation circuit 10 shown in FIG. 3 that controls the transfer of the display data DATA on the bus 40. The transfer clock generation circuit 10 generates the transfer clock XSCL used for transferring the display data DATA. Moreover, the transfer clock generation circuit 10 has a function of adjusting a clock frequency fTRANS of the transfer clock XSCL.

More specifically, the transfer clock generation circuit 10 monitors the transfer clock XSCL generated by itself. Then, the transfer clock generation circuit 10 adjusts the transfer clock XSCL such that the clock frequency fTRANS of the monitored transfer clock XSCL is corrected to a predetermined frequency. Information (REF) on the predetermined frequency is stored in a register 60 connected to the transfer clock generation circuit 10. The transfer clock generation circuit 10 adjusts the clock frequency fTRANS by referring to the information REF stored in the register 60.

For example, the information REF stored in the register 60 is a data indicating an optimum frequency (refer to the expression (7)) for the transfer of the display data DATA. The transfer clock generation circuit 10 can maintain the clock frequency fTRANS at the optimum value by comparing the monitored frequency and the optimum frequency indicated by the register 60. Alternatively, the information REF stored in the register 60 can be an optimum number of clock pulses that should be generated within a predetermined period. The transfer clock generation circuit 10 can maintain the clock frequency fTRANS at the optimum value by comparing the number of pulses of the transfer clock XSCL detected within the predetermined period and the optimum number indicated by the register 60.

In this manner, the transfer clock XSCL generated by the transfer clock generation circuit 10 is fed back to adjust the clock frequency fTRANS of the transfer clock XSCL. As a result, even if the clock frequency fTRANS of the transfer clock XSCL varies due to change in voltage, temperature or the like, the clock frequency fTRANS is immediately set back to the predetermined frequency. That is to say, the clock frequency fTRANS of the transfer clock XSCL is controlled to be maintained at the optimum value.

According to the present embodiment, the variation of the clock frequency fTRANS caused by voltage change, temperature change, manufacturing variability and the like is absorbed as a result of the control by the transfer clock generation circuit 10. Therefore, it is not necessary to set the design frequency fTRANS(set) in consideration of the voltage change, the temperature change, the manufacturing variability and the like. Consequently, the constraint imposed on the design frequency fTRANS(set) is relaxed (refer to the foregoing expression (7)). Thus, it becomes easier to deal with the increase in the total number of pixels of the LCD panel 1. In other words, it is possible to easily realize large screen size (mega-pixel) which requires high-speed transfer of a large amount of data (refer to the foregoing expression (8)).

Hereinafter, a configuration example and an operation example of the LCD controller 2 according to the present embodiment will be described in detail. The LCD controller 2 according to the present embodiment is provided as a “liquid crystal display control IC” into which the transfer clock generation circuit 10, the common driver 20, the segment driver 30 and the VRAM 50 shown in FIG. 3 are built.

### 2. CONFIGURATION EXAMPLE

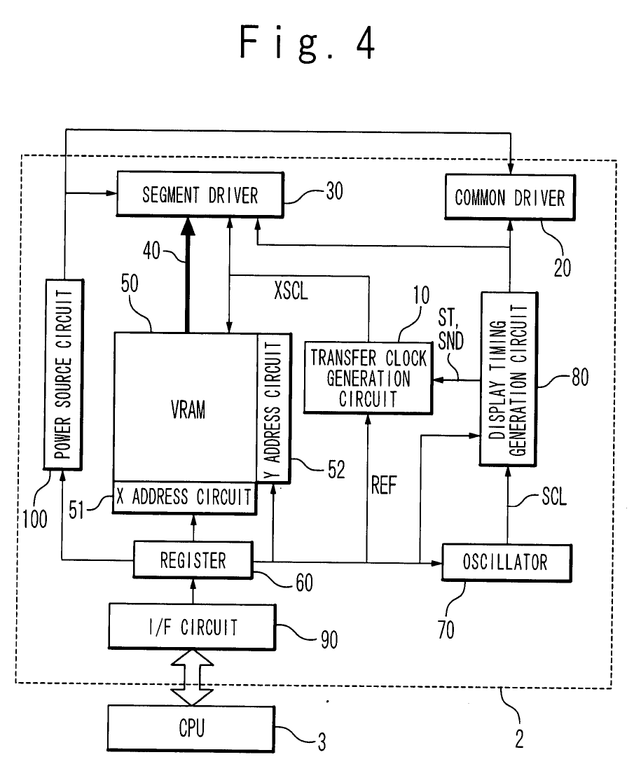

FIG. 4 shows an example of a configuration of the LCD controller 2 according to the present embodiment. The LCD controller 2 is provided with the transfer clock generation circuit 10, the common driver 20, the segment driver 30, the bus 40, the VRAM 50, an X address circuit 51, a Y address circuit 52, the register 60, an oscillator 70, a display timing generation circuit 80, an I/F circuit 90 and a power source circuit 100.

The LCD controller 2 is connected to the CPU 3 through the I/F circuit 90. The data transmitted from the CPU 3 is written to the register 60 through the I/F circuit 90. The register 60 is connected to the transfer clock generation circuit 10, the X address circuit 51, the Y address circuit 52, the oscillator 70, the display timing generation circuit 80 and the power source circuit 100, and is used for various settings within the LCD controller 2.

The display data DATA transmitted from the CPU 3 is also written to the register 60 through the I/F circuit 90. Moreover, the display data DATA is written to the VRAM 50 from the register 60. At this time, the X address circuit 51 and the Y address circuit 52 generate a target address on the VRAM 50 to which the display data DATA is written.

The oscillator 70 generates a source oscillation clock SCL and supplies the source oscillation clock SCL to the display timing generation circuit 80.

The display timing generation circuit 80 performs frequency division of the source oscillation clock SCL to generate timing signals used for the displaying. Then, the display timing generation circuit 80 outputs the timing signals to the common driver 20 and the segment driver 30 and thereby controls operations of the drivers. Furthermore, based on the timing signals, the display timing generation circuit 80 outputs a start signal ST and a NODISP signal SND, which will be described later, to the transfer clock generation circuit 10.

The power source circuit 100 generates drive voltages relating to the LCD panel. The power source circuit 100 is connected to the common driver 20 and the segment driver 30, and supplies drive voltages for driving the scan lines and the data lines (LCD panel) to the common driver 20 and the segment driver 30, respectively.

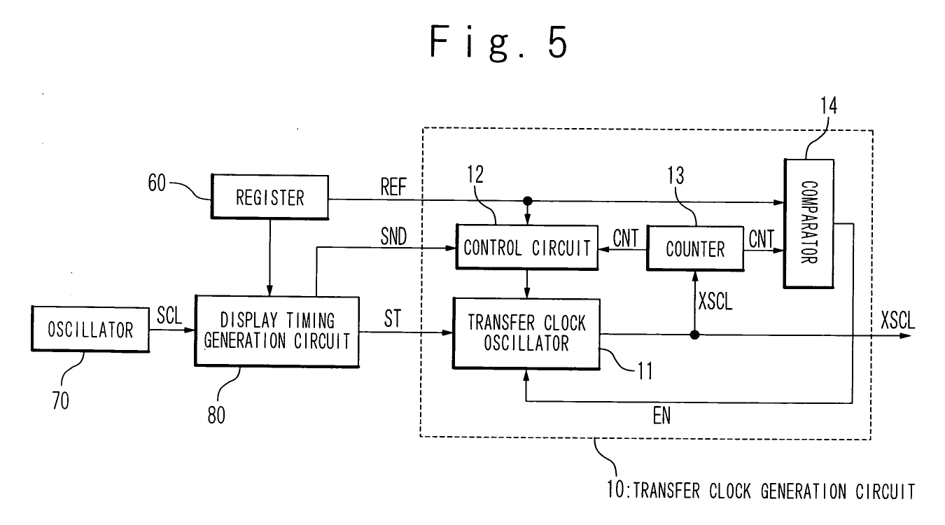

FIG. 5 shows an example of a configuration of the transfer clock generation circuit 10 according to the present embodiment. The transfer clock generation circuit 10 shown in FIG. 5 includes a transfer clock oscillator 11, a control circuit 12, a counter 13 and a comparator 14.

The transfer clock oscillator 11 is an oscillator for oscillating the transfer clock XSCL. The transfer clock oscillator 11 receives the start signal ST from the display timing generation circuit 80. The start signal ST is a signal that directs to start the transfer of the display data DATA. In response to the start signal ST, the transfer clock oscillator 11 generates (oscillates) the transfer clock XSCL at a certain oscillation frequency fTRANS. It should be noted that the oscillation frequency fTRANS is variably set by the control circuit 12.

The counter 13 monitors the transfer clock XSCL generated by the transfer clock oscillator 11, and counts the number of the pulses of the transfer clock XSCL within a predetermined period. A count value CNT within the predetermined period is output to the control circuit 12 and the comparator 14. The predetermined period is the one line period during which the display data DATA of one line is transferred.

Set in the register 60 is the optimum number REF (hereinafter, referred to as a “reference pulse number REF”) of the clock pulses that should be generated within the one line period. The reference pulse number REF is a parameter corresponding to the design frequency fTRANS(set). The reference pulse number REF is supplied from the register 60 to the control circuit 12 and the comparator 14.

The control circuit 12 corrects the oscillation frequency fTRANS on the basis of a ratio between the count value CNT counted by the counter 13 and the reference pulse number REF set in the register 60. More specifically, by using the count value CNT and the reference pulse number REF, the control circuit 12 calculates a “correction factor γ” that is given by the following equation:
Correction factor γ=(reference pulse number REF)/(count value CNT) (9)

Then, the control circuit 12 multiplies the present oscillation frequency fTRANS by the calculated correction factor γ to set a new oscillation frequency fTRANS. For example, the control circuit 12 outputs a control signal indicating the correction factor γ to the transfer clock oscillator 11, and the transfer clock oscillator 11 adjusts the oscillation frequency fTRANS in accordance with the control signal. In this manner, the oscillation frequency fTRANS is corrected to the predetermined frequency (REF) by the control circuit 12. In other words, the control circuit 12 can maintain the oscillation frequency fTRANS at a predetermined optimum frequency corresponding to the reference pulse number REF, by calculating the correction factor γ.

Also, the control circuit 12 receives the NODISP signal SND from the display timing generation circuit 80. The NODISP signal SND is activated in a “non-display period” during which an image corresponding to the display data DATA is not displayed on the LCD panel 1. The control circuit 12 according to the present embodiment adjusts (optimizes) the oscillation frequency fTRANS, only when the NODISP signal SND is activated. In other words, the control circuit 12 optimizes the oscillation frequency fTRANS in the non-display period. It can be also said that the NODISP signal SND is a signal which directs the optimization of the oscillation frequency fTRANS.

The above-mentioned non-display period is exemplified by an “initial line period (first line period)” corresponding to an initial line (first line) of one frame. In the initial line period, the display data DATA of the initial line is transferred to the segment driver 30. In the next line period, the display data DATA of the initial line is displayed on the LCD panel 1, while the display data DATA of the next line is transferred to the segment driver 30. In such the initial line period, the optimization of the oscillation frequency fTRANS is carried out.

In a display period other than the non-display period, the comparator 14 makes a comparison between the count value CNT counted by the counter 13 and the reference pulse number REF set in the register 60. An enable signal EN that is an output of the comparator 14 represents the comparison result and controls the transfer clock oscillator 11. For example, when the count value CNT is less than the reference pulse number REF, the enable signal EN is set to “High”. In this case, the transfer clock oscillator 11 is activated. On the other hand, when the count value CNT becomes equal to or more than the reference pulse number REF, the enable signal EN is changed to “Low (Disable)”. In this case, the transfer clock oscillator 11 is deactivated.

### 3. FLOW OF OPERATION

An overall operation of the LCD controller 2 will be described below with reference to the foregoing FIG. 4. First, an operation of writing the display data DATA to the VRAM 50 is as follows. In accordance with a command issued by the CPU 3, the X address circuit 51 and the Y address circuit 52 specify an address on the VRAM 50 to which data is written. Next, the display data DATA transmitted from the CPU 3 is written to the specified address on the VRAM 50 through the I/F circuit 90 and the register 60.

An operation of displaying an image corresponding to the display data DATA is as follows. The display timing generation circuit 80 generates timing signals necessary for the displaying, based on the source oscillation clock SCL generated by the oscillator 70. Then, the display timing generation circuit 80 outputs the timing signals to the common driver 20 and the segment driver 30. In accordance with the received timing signals, the common driver 20 and the segment driver 30 drive the scan lines and the data lines, respectively.

Simultaneously, the display data DATA is transferred from the VRAM 50 to the segment driver 30. More specifically, in accordance with a command issued by the CPU 3, the X address circuit 51 and the Y address circuit 52 specify an address on the VRAM 50 from which data is read out. Then, the display data DATA of one line is read out from the specified address on the VRAM 50. The read display data DATA corresponding to the one line is output to the bus 40. The output display data DATA is transferred to the segment driver 30 in synchronization with the transfer clock XSCL.

The transfer clock XSCL is generated by the transfer clock generation circuit 10. An operation of the transfer clock generation circuit 10 is controlled by the display timing generation circuit 80. More specifically, the display timing generation circuit 80 generates the start signal ST and the NODISP signal SND on the basis of the timing signals, and outputs the start signal ST and the NODISP signal SND to the transfer clock generation circuit 10. The start signal ST is the signal that directs to start the transfer of the display data DATA. The NODISP signal SND is the signal that directs to optimize the oscillation frequency fTRANS. In response to the start signal ST and the NODISP signal SND, the transfer clock generation circuit 10 carries out the following processing.

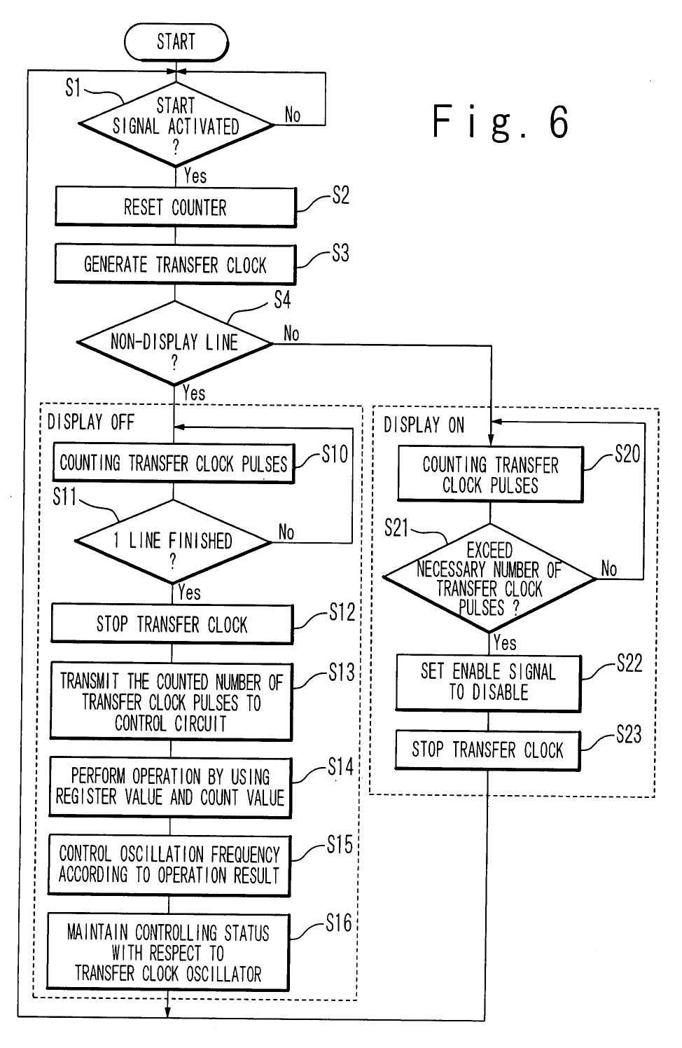

FIG. 6 is a flow chart showing the operation of the transfer clock generation circuit 10 according to the present embodiment. The operation flow of the transfer clock generation circuit 10 will be described below with reference to the foregoing FIG. 5 and FIG. 6.

The transfer clock oscillator 11 is in a stand-by status until the start signal ST is activated (Step S1). When the start signal ST is activated (Step S1; Yes), the counter 13 is reset (initialized), and hence the count value CNT is set to “0” (Step S2). Also, the transfer clock oscillator 11 generates the transfer clock XSCL at a certain oscillation frequency fTRANS(Step S3). The display data DATA of one line is transferred in synchronization with the transfer clock XSCL.

Referring to the NODISP signal SND, the control circuit 12 judges whether the present line is a “display line” or the “non-display line” (Step S4). In the case of the non-display line (Step S4; Yes), the optimization of the transfer clock XSCL is carried out in addition to the transfer of the display data DATA (Steps S10 to S16). On the other hand, in the case of the display line (Step S4; No), the usual transfer process is carried out (Steps S20 to S23). In the present embodiment, the non-display line is the initial line of one frame.

In the initial line period, the counter 13 counts the number of pulses of the transfer clock XSCL (Steps S10, S11). When the initial line is finished (Step S11; Yes), the transfer clock oscillator 11 stops generating the transfer clock XSCL (Step S12).

Next, the count value CNT counted by the counter 13 is transmitted to the control circuit 12 (Step S13). The count value CNT represents the number of pulses of the transfer clock XSCL within the one line period. Subsequently, the control circuit 12 calculates the correction factor γ by using the count value CNT and the reference pulse number REF set in the register 60 (Step S14). The correction factor γ is given by the above-described equation (9).

Next, by using the calculated correction factor γ, the control circuit 12 performs the frequency correction such that the oscillation frequency fTRANS becomes the optimum frequency (Step S15). More specifically, the control circuit 12 multiplies the present oscillation frequency fTRANS by the calculated correction factor γ and thereby sets a new oscillation frequency fTRANS. In this manner, the control circuit 12 controls the oscillation frequency fTRANS to be the optimum frequency.

The control circuit 12 maintains the controlling status with respect to the transfer clock oscillator 11 until the next optimization process is performed (Step S16). That is to say, the oscillation frequency fTRANS is kept at the optimum value after the initial line period until the one frame is completed. In an initial line period of the next frame, the oscillation frequency fTRANS may be corrected again (Steps S10 to S15). Therefore, even if the frequency fTRANS of the transfer clock XSCL is varied due to change in voltage and temperature, the frequency fTRANS is immediately corrected to the predetermined optimum value.

When the next line is started, the NODISP signal SND is deactivated, while the start signal ST is activated again (Step S1; Yes). In response to the activation of the start signal ST, the counter 13 is reset (Step S2). Also, the transfer clock oscillator 11 generates the transfer clock XSCL at the oscillation frequency fTRANS after the correction (Step S3). The display data DATA of one line is transferred in synchronization with the transfer clock XSCL.

Also, the control circuit 12 refers to the deactivated NODISP signal SND and recognizes that the present line is a “display line” (Step S4; No). In this case, the control circuit 12 activates the comparator 14. Then, the transfer process in the display period is carried out (Steps S20 to S23).

In the display line period, the counter 13 counts the number of pulses of the transfer clock XSCL (Step S20). In the comparator 14, the count value CNT is always compared with the reference pulse number REF set in the register 60 (Step S21). When the count value CNT is less than the reference pulse number REF (Step S21; No), the enable signal EN is set to “High”. In this case, the transfer clock oscillator 11 continues to generate the transfer clock XSCL, and the counter 13 continues to count (Step S20).

On the other hand, if the count value CNT becomes equal to or more than the reference pulse number REF (Step S21; Yes), the enable signal EN is changed from “High” to “Low”. That is, the enable signal EN is set to “Disable” (Step S22). In this case, the transfer clock oscillator 11 is deactivated and stops generating the transfer clock XSCL (Step S23). An effect resulting from such the process is as follows.

Even in the period after the oscillation frequency fTRANS is optimized and until the next one frame is finished, there is a possibility that the oscillation frequency fTRANS increases rapidly due to rapid increase in temperature or the like. To generate clock pulses more than necessary for transferring the display data DATA of one line is waster of electric power consumption. Therefore, the enable signal EN is set to “Disable” at the time when the count value CNT reaches the reference pulse number REF. Consequently, unnecessary electric power consumption can be reduced.

In a case where the enable signal EN is being held at “Enable”, the transfer clock oscillator 11 stops generating the transfer clock XSCL at the time when the present line is finished (Step S23). A similar processing as described above is carried out in the next line.

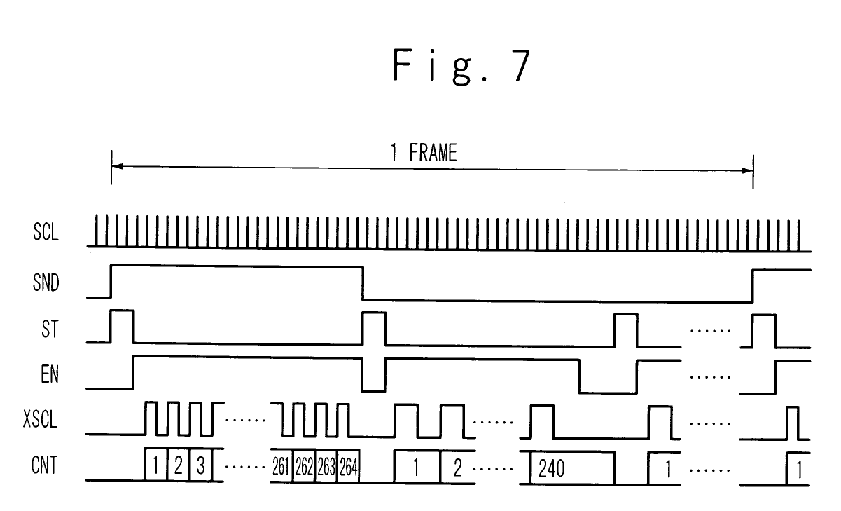

FIG. 7 is a timing chart showing one example of the operation of the transfer clock generation circuit 10 according to the present embodiment. Shown in FIG. 7 are the source oscillation clock SCL, the NODISP signal SND, the start signal ST, the enable signal EN, the transfer clock XSCL and the count value CNT. In the present operation example, the size of the LCD panel 1 is QVGA (240×320 pixels) and the reference pulse number REF set in the register 60 is 240.

When one line is started, the display timing generation circuit 80 generates the start signal ST and the NODISP signal SND based on the source oscillation clock SCL. The initial line of the frame corresponds to the non-display period and thus the NODISP signal SND is activated. In response to the fall of the start signal ST, the transfer clock oscillator 11 starts generating the transfer clock XSCL prior to the correction. The counter 13 is first reset and then starts counting the number of pulses of the generated transfer clock XSCL.

Let us consider a case where the count value CNT at the time when the initial line is finished is 264, for example. Based on the reference pulse number REF (=240) and the count value CNT (=264), the control circuit 12 calculates the correction factor γ. According to the above-described equation (9), the correction factor γ is calculated to be 240/260. Therefore, the control circuit 12 multiplies the oscillation frequency fTRANS by 240/260. As a result, the oscillation frequency fTRANS is decreased and corrected to the frequency corresponding to the reference pulse number REF.

The next line corresponds to a display period, and thus the NODISP signal SND is deactivated. Therefore, the optimization of the oscillation frequency fTRANS is not performed. In response to the fall of the start signal ST, the transfer clock oscillator 11 starts generating the transfer clock XSCL after the correction. The counter 13 is first reset and then starts counting the number of pulses of the generated transfer clock XSCL.

During the period of the display line, the comparator 14 makes a comparison between the count value CNT and the reference pulse number REF (=240). When the count value CNT is less than 240, the enable signal EN is at “High”. When the count value CNT becomes 240, the enable signal EN is changed to “Low (disable)”. Thus, the transfer clock oscillator 11 is deactivated and stops generating the transfer clock XSCL.

### 4. MODIFICATION EXAMPLE

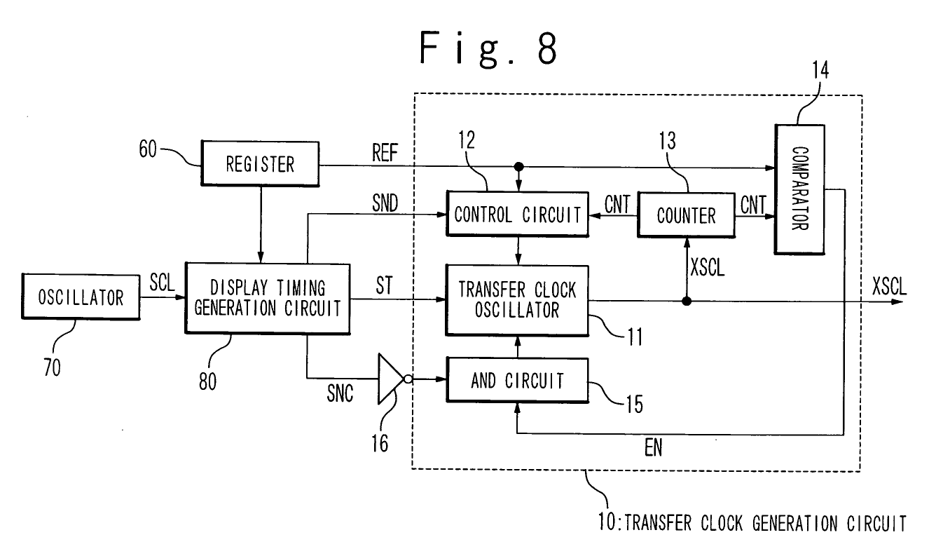

FIG. 8 shows a modification example of the transfer clock generation circuit 10 according to the present embodiment. In FIG. 8, the same reference numerals are given to the same components as those described above, and an overlapping description will be appropriately omitted.

The transfer clock generation circuit 10 shown in FIG. 8 further includes an AND circuit 15. The enable signal EN output from the comparator 14 is input to the AND circuit 15. Also, a NOCLK signal SNC output from the display timing generation circuit 80 is input to the AND circuit 15 through an inverter 16. The AND circuit 15 performs an AND operation between the enable signal EN and an inversion signal of the NOCLK signal SNC, and outputs the operation result to the transfer clock oscillator 11.

The NOCLK signal SNC is a signal for interrupting the generation of the transfer clock XSCL at an arbitrary timing during one line period. The display timing generation circuit 80 sets the NOCLK signal SNC to “High” in a period during which the generation of the transfer clock XSCL is interrupted, while sets the NOCLK signal SNC to “Low” in a period during which the transfer clock XSCL is generated. When the NOCLK signal SNC is “High”, the output of the AND circuit 15 is “Low” even if the enable signal EN is “High”. In this case, the transfer clock oscillator 11 is deactivated.

In this manner, the generation of the transfer clock XSCL is interrupted during the NOCLK signal SNC is set to “High”. To put it the other way around, it is possible by using the NOCLK signal SNC to interrupt the generation of the transfer clock XSCL at a specified timing during one line period. That is to say, it is possible to freely control the generation period of the transfer clock XSCL during the one line period. As a result, the following effect can be obtained.

At the time when the display data DATA is transferred, the bus 40 operates at a high-speed, which causes current noise to occur. The noise can propagate through the ground to the power source circuit 100, the segment driver 30 and the common driver 20 shown in FIG. 4. Therefore, image quality may be deteriorated depending on the timing of the noise occurrence. According to the modification example, however, it is possible to freely control the generation period of the transfer clock XSCL during the one line period. That is, it is possible to remove the generation period of the transfer clock XSCL from a display stable period with regard to the display data DATA that is presently displayed. Consequently, the deterioration of the image quality caused by the noise can be prevented.

It is apparent that the present invention is not limited to the above embodiments and may be modified and changed without departing from the scope and spirit of the invention.

What is claimed is:

1. A display controller comprising:
a memory in which a display data is stored;
a driver configured to drive a display panel in response to said display data; and
a clock generation circuit configured to generate a clock that is used for transferring said display data from said memory to said driver,
wherein said generated clock is fed back to adjust a clock frequency of said clock.

2. The display controller according to claim 1,
wherein said clock generation circuit monitors said generated clock, and adjusts said clock frequency such that a frequency of said monitored clock is corrected to a predetermined frequency.

3. The display controller according to claim 2,
wherein said clock generation circuit generates said clock at a first frequency,
wherein said clock generation circuit calculates a ratio between said frequency of said monitored clock and said predetermined frequency, and corrects said first frequency by using said calculated ratio.

4. The display controller according to claim 1,
wherein said clock generation circuit monitors said generated clock, and adjusts said clock frequency such that a number of pulses of said monitored clock within a predetermined period is corrected to a predetermined value.

5. The display controller according to claim 4,
wherein said clock generation circuit generates said clock at a first frequency,
wherein said clock generation circuit calculates a ratio between said number of pulses within said predetermined period and said predetermined value, and corrects said first frequency by using said calculated ratio.

6. The display controller according to claim 5,
wherein said clock generation circuit includes:
an oscillator configured to generate said clock at said first frequency;
a counter configured to count a number of pulses of said generated clock within said predetermined period; and
a control circuit configured to change said first frequency based on said ratio between said number of pulses within said predetermined period and said predetermined value set in a register.

7. The display controller according to claim 4,
wherein said predetermined period corresponds to one line period during which said display data is transferred.

8. The display controller according to claim 1,
wherein said adjustment of said clock frequency is performed in a non-display period during which an image corresponding to said display data is not displayed on said display panel.

9. The display controller according to claim 4,
wherein said clock generation circuit adjusts said clock frequency in a non-display period during which an image corresponding to said display data is not displayed on said display panel.

10. The display controller according to claim 9,
wherein in other than said non-display period, said clock generation circuit stops generating said clock when said number of pulses within said predetermined period becomes equal to said predetermined value.

11. The display controller according to claim 9,
wherein said clock generation circuit interrupts generation of said clock at a specified timing during said predetermined period.

12. The display controller according to claim 8,
wherein said non-display period corresponds to an initial line of a frame.

13. The display controller according to claim 9,
wherein said non-display period corresponds to an initial line of a frame.

14. A method of transferring a display data in a display device which includes a memory storing a display data and a driver driving a display panel in response to said display data, comprising:
(A) generating a clock that is used for transferring said display data from said memory to said driver;
(B) transferring said display data by using said generated clock;
(C) counting a number of pulses of said generated clock within a predetermined period; and
(D) adjusting a clock frequency of said clock such that said number of pulses within said predetermined period is corrected to a predetermined value.

15. The method according to claim 14,
wherein said predetermined period corresponds to a period of said (B) step.

16. The method according to claim 14,
wherein said (D) step is performed in a non-display period during which an image corresponding to said display data is not displayed on said display panel.

17. The method according to claim 16,
wherein said non-display period corresponds to an initial line of a frame.

18. The method according to claim 16, further comprising:
(E) after said (D) step, repeating said (A) to (C) steps by using said adjusted clock frequency.

19. The method according to claim 18, further comprising:
(F) in said (E) step, stopping generation of said clock when said number of pulses within said predetermined period becomes equal to said predetermined value.

20. The method according to claim 14, further comprising:
(G) interrupting generation of said clock at a specified timing during said predetermined period.
